(19) United States
(12) Patent Application Publication
(10) Pub. No.: US 2008/0127229 A1
(43) Pub. Date: May 29, 2008

(54) MULTIPLE INTERFACE STANDARD SUPPORT FOR REDUNDANT ARRAY OF INDEPENDENT DISKS

(75) Inventors: Don S. Keener, Apex, NC (US); Adam Roberts, Moncure, NC (US); Philip L. Weinstein, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Cropration, Armonk, NY (US)

(21) Appl. No.: 11/530,223

(22) Filed: Sep. 8, 2006

(51) Int. Cl. G06F 13/00; G06F 3/00

(52) U.S. Cl. 719/325; 719/326

(57) ABSTRACT

A method for supporting multiple interface standards in a connection between a computer system and a Redundant Array of Independent Disks (RAID) unit is disclosed. The method includes receiving a message indicating an initialization routine and reading a first indicator associated with a first interface standard. The method further includes loading configuration data for the first interface standard. The method further includes configuring a RAID initiator using the configuration data, if the first interface standard is identical to the actual interface standard to which the RAID unit is coupled.

### BACKGROUND OF THE INVENTION

1. Field of the Invention

The present invention relates to the field of network servers and more specifically to the integration of Redundant Arrays of Independent Disks (RAID) units with network servers.

2. Description of the Related Art

A network server, often used with a RAID unit, is a computer or device on a network that manages network resources such as network traffic. A RAID unit is a disk drive that employs two or more drives in combination for fault tolerance and performance. In most RAID units, the same data is stored in different places (thus, redundantly) on multiple hard disks. By placing data on multiple disks, I/O (input/output) operations can overlap in a balanced way, improving performance. Since multiple disks increase the mean time between failures, storing data redundantly also increases fault tolerance. RAID units are widely used in datacenters to secure data and improve system management.

An increasing problem for providers of RAID units is compatibility with interface standards. Providers must consider the interface standards used by the existing systems of their customers. Typically, customers' existing systems will use either the Small Computer System Interface (SCSI) or Serial Attached SCSI (SAS) parallel interface standards. SCSI is a parallel interface standard used by Apple Macintosh computers, PCs, and many UNIX systems for attaching peripheral devices such as disk drives and printers to computers. SCSI interfaces provide for faster data transmission rates (up to 80 megabytes per second) than standard serial and parallel ports. Certain SCSI bus implementations are capable of speeds up to 320 megabytes per second per bus. SAS is an evolution of parallel SCSI into a point-to-point serial peripheral interface in which controllers are linked directly to disk drives. SAS supports full-duplex signal transmission. SAS is capable of speeds up to 3 gigabits per second per port.

One approach to the problem of multiple interface standards is to provide multiple card options with the RAID units being offered. That is, the provider must supply two separate card options—one for existing systems that use the SCSI interface standard and one for existing systems that use the SAS interface standard. This increases the complexity of the process of integrating a RAID unit with an existing system. Further, the SCSI and SAS cards employ different configuration data that is used during boot-up of a computer system. Thus, if a SCSI card is connected to a system that uses the SAS standard, the SCSI card will not be recognized. Likewise, if a SAS card is connected to a system that uses the SCSI standard, the SAS card will not be recognized. This can lead to confusion and irritation during the integration process.

Another problem with the approach described above is system failure. A problem encountered by this approach was that the card was not loaded properly and therefore led to failure of the computer system to recognize the controller of the RAID unit. Therefore, the computer system was not able to integrate the RAID unit using the correct interface standard.

Thus, the need arises to solve the problems with the prior art above and specifically for a more efficient way to handle multiple interface standards when integrating a RAID unit with an existing system.

### BRIEF SUMMARY OF THE INVENTION

Embodiments of the invention address deficiencies of the art in respect to supporting multiple interface standards and provide a novel and non-obvious method, apparatus and computer program product for supporting multiple interface standards in a connection between a computer system and a Redundant Array of Independent Disks (RAID) unit. In one embodiment of the present invention, a method for supporting multiple interface standards in a connection between a computer system and a RAID unit comprises receiving a message indicating an initialization routine and reading a first indicator associated with a first interface standard. The method further includes loading configuration data for the first interface standard. The method further includes configuring a RAID initiator using the configuration data, if the first interface standard is identical to the actual interface standard to which the RAID unit is coupled.

In another embodiment of the present invention, the method further includes storing a second indicator associated with a second interface standard, if the first interface standard is not identical to the actual interface standard, and re-initiating the initialization routine. In another embodiment of the present invention, the method further includes reading the second indicator associated with the second interface standard, loading configuration data for the second interface standard and configuring the RAID initiator using the configuration data, since the second interface standard is identical to the actual interface standard to which the RAID unit is coupled.

In another embodiment of the present invention, an apparatus for supporting multiple interface standards in a connection between a computer system and a RAID unit includes a receiver for receiving a message indicating an initialization routine and memory for storing a first indicator associated with a first interface standard. The apparatus may further include a processor configured for reading the first indicator, loading configuration data for the first interface standard and configuring a RAID initiator using the configuration data, if the first interface standard is identical to the actual interface standard to which the RAID unit is coupled.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a computer system 100 for supporting multiple interface standards in a connection between a computer system and a RAID unit, according to one embodiment of the present invention; and,

FIG. 2 is a flow chart illustrating a process for supporting multiple interface standards in a connection between a computer system and a RAID unit, according to one embodiment of the present invention.

### DETAILED DESCRIPTION OF THE INVENTION

Embodiments of the invention address deficiencies of the art in respect to supporting multiple interface standards and provide a novel and non-obvious method, apparatus and computer program product for supporting multiple interface standards in a connection between a computer system and a Redundant Array of Independent Disks (RAID) unit. The method of the present invention includes receiving, by a PCI card, a message, such as a BIOS message, from a computer system and reading, by a PCI card, a first indicator associated with a first interface standard, such as either the SCSI or SAS interface standards. Then, configuration data for the first interface standard is loaded by the PCI card. If the first interface standard is identical to the actual interface standard, the loading process will not produce any errors and POST will complete. If the two are not identical, the first indicator is modified to reflect the actual interface standard and the system is automatically reset. The features of the present invention are advantageous as multiple interface standards for a connection for a RAID unit are supported and configuration of the interface standard is automatically executed during boot-up of the computer system. This allows for greater compatibility of RAID units with existing computer systems and decreases the complexity and time requirements associated with boot-up of computer systems with RAID units. Another benefit of the present invention is a cost savings for the RAID unit manufacturer as well as the end consumer, since there is no need for multiple cards supporting multiple interface standards.

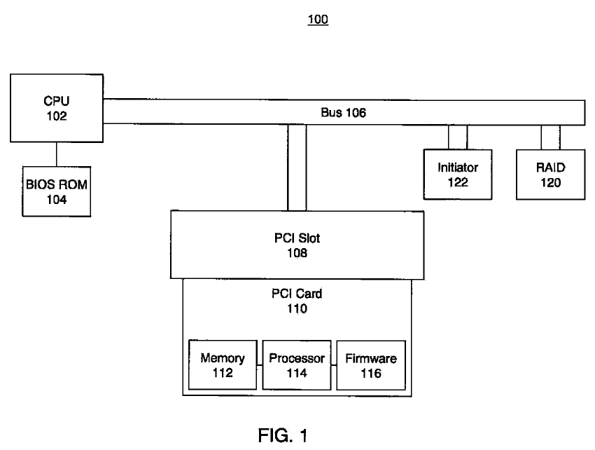

FIG. 1 is a schematic illustration of a computer system 100 for supporting multiple interface standards in a connection between a computer system and a RAID unit, according to one embodiment of the present invention. FIG. 1 shows an existing computer system of a customer, comprising a Central Processing Unit (CPU) 102, a ROM 104 and communications bus 106. The computer system represented by 100 may be one or more Personal Computers (PCs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer system represented by 100 is a server system, such as SUN Ultra workstations running a SunOS operating system or IBM RS/6000 workstations and servers running the AIX operating system.

Connected to the CPU 102 is a BIOS ROM 104 including initialization instructions that are executed when a user of the computer system 100 powers on the machine. The Basic Input Output System (BIOS) and Power on Self Test (POST) programs of the computer system 100 are initiated during boot-up of the machine. BIOS refers to the built-in software that determines what a computer can do without accessing programs from a disk. On PCs, the BIOS contains all the code required to control the keyboard, display screen, disk drives, serial communications, and a number of miscellaneous functions. POST refers to a diagnostic testing sequence run by a computer's BIOS as the computer's power is initially turned on. The POST determines if the computer's RAM, disk drives, peripheral devices and other hardware components are properly working. If the diagnostic determines that everything is in working order, the computer will continue to boot. The BIOS and POST are typically placed in a ROM chip (104) that comes with the computer system 100, and are commonly referred to as POST/BIOS.

A bus is a collection of wires through which data is internally transmitted from one part of a computer to another. A bus connects all the internal computer components to the CPU and main memory. Indirectly connected to the CPU 102 is a bus 106, which is a Peripheral Component Interconnect eXtended (PCI-X) bus. PCI-X is a local bus standard used by most modem PCs. PCI-X is a 64-bit bus, running at speeds of 66 MHz, 100 Mhz and 133 Mhz. The PCI-X bus is capable of backward compatibility to the PCI bus, so a PCI card can run in a PCI-X bus. Coupled with bus 106 is slot 108 for inserting a PCI or PCI-X card. It should be noted that although the interface standard described for slot 108 is PCI, the present invention supports other interface standards such as an Integrated Drive Electronics (IDE) interface for mass storage devices, in which the controller is integrated into the disk it services.

Also indirectly connected to the CPU 102 is a bus 126. In one embodiment of the present invention, the communications bus 126 maybe any one of a plurality of interface standards, such as the Small Computer System Interface (SCSI) parallel interface standard or the Serial Attached SCSI (SAS) serial standard.

FIG. 1 further shows PCI card 110 connected to slot 108. PCI card 110 substantially executes the method of the present invention. It should be noted that although FIG. 1 shows PCI card 110 existing as a separate entity, in another embodiment the PCI card 110 may be integrated into other entities of FIG. 1. Alternatively, the functions of PCI card 110 may be distributed over more than one entity as in a distributed computing paradigm.

PCI card 110 comprises a processor 114, such as a silicon chip, that controls the logic and substantially performs the necessary functions of the PCI card 110. The PCI card 110 offloads processing tasks from the main CPU 102, such as parity-generating functions. PCI card 110 further includes a memory 112 for storing information and firmware 116 including computer logic for execution by the processor 114 for facilitating certain functions such as communicating with the initiator 122. PCI card 110 may further include a transmitter/receiver (not shown) for sending and receiving messages, instructions or signals to and from the processor 114 and communicating with outside entities, such as initiator 122.

FIG. 1 further shows RAID unit 120, which is a disk drive that employs two or more drives in combination for fault tolerance and performance, coupled with initiator 122. In a RAID unit, the same data is stored in different places on multiple hard disks. In one embodiment of the present invention, the RAID unit 120 is a commercially available RAID unit comprising a hard disk that performs RAID functions, such as the IBM TotalStorage DS6000 series of RAID units, available from IBM or Armonk, N.Y. It should be noted that although FIG. 1 shows only one RAID unit 120, the system 100 of the present invention supports any viable number of RAID units.

Lastly, FIG. 1 shows a RAID initiator 122, which substantially controls the RAID 120, connected to bus 126. The RAID initiator 122 may perform a variety of functions such as relaying communications between the PCI card 110 and the RAID unit 120. The RAID initiator 122 may further provide a central, unified environment for simplifying the management of RAID 120 and other critical monitoring and management activities.

When the PCI card 110 is not present, the computer system 100 recognizes the RAID initiator 122 as a non-RAID SCSI initiator or a non-RAID SAS initiator. When the PCI card 110 is present and coupled to the PCI slot 108, the computer system 100 recognizes the RAID initiator 122 as a RAID SCSI or SAS initiator, depending on which type of firmware is loaded. See below for a more detailed description of this function.

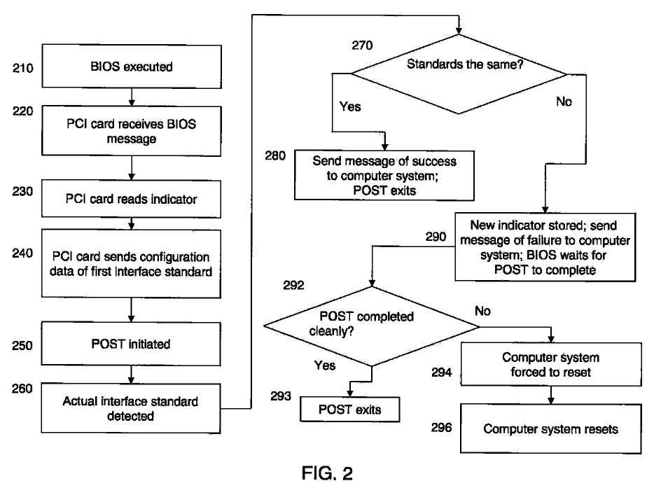

FIG. 2 is a flow chart illustrating a process for supporting multiple interface standards in a connection between a computer system 100 and a RAID unit 120, according to one embodiment of the present invention. Notably, the process can be performed by a PCI card 110 within a computer system 100 for supporting multiple interface standards of the bus 106 between the CPU 102 and a RAID unit 120, such as the SCSI and SAS interface standards. Beginning in block 210, the BIOS of the computer system 100 is executed. BIOS provides a set of software routines that allow high level software to interact with the hardware components of the computing system 100 using standard calls.

An important function of BIOS is the initialization of the computing system 100. As part of this initialization process, BIOS performs a number of tasks, such as initializing and testing the hardware components of the computing system 100 and starting the operating system resident in the computing system 100. During this process, in block 220, the processor 114 of the PCI card 110 receives a message or instruction from the BIOS initialization routine indicating that initialization has started. In response, in block 230 the processor 114 of the PCI card 110 reads an indicator associated with a first interface standard from the memory 112. In one example, the interface standard may be SCSI or SAS and the indicator may be a single bit that indicates SCSI when set to ‘1’ and indicates SAS when set to ‘0.’ In another example, the interface standard may be any number of supported interface standards and the indicator may be any number of bits necessary to represent the multiple interface standards. In one embodiment, the indicator may represent the interface standard which was last successfully configured by the PCI card 110. In another embodiment, the indicator may be preset or may be randomly assigned.

In block 240, the processor 114 of the PCI card 110 loads the configuration data, such as the firmware, associated with the first interface standard for the initiator 122 and the RAID unit 120. The initialization and testing of the hardware during the BIOS initialization routine is performed by a routine referred to as Power On Self Test (POST). In block 250, POST is initiated. POST is a series of functions or routines that perform various initialization and tests of the hardware. For example, POST includes code for testing the CPU 102, math coprocessor, timer integrated circuits, controllers, etc. of the motherboard of the computer system 100. Further, POST performs various memory checks and initializations. POST also tests and initializes various devices that may be installed in the computing system 100, such as video ROM, network adapter cards, SCSI adapter cards, etc. If these devices are present, their contents are tested with a checksum test and initialization of the devices. After POST has finished, BIOS initiates the operating system of the computer.

If the actual interface standard to which the RAID units 120 is attached is identical to the first interface standard (see block 270), then control flows to block 280. If the actual interface standard to which the RAID units 120 is attached is not identical to the first interface standard (see block 270), then control flows to block 290. In block 280, the initiator 122 and the RAID unit 120 were successfully configured with the aid of the PCI card 110, thereby allowing POST to complete and exit. Subsequently, the BIOS may initiate the operating system of the computer system 100.

In block 290, the configuration process fails, thereby delaying the error-free completion of POST. Subsequently, the processor 114 of the PCI card stores in memory 112 an indicator associated with the actual (or second) interface standard. Further in block 290, the processor 114 of the PCI card 110 resets the PCI card 110. Then, the PCI card 110 loads the configuration data, such as firmware, associated with the second interface standard for the initiator 122 and the RAID unit 120. Lastly, the BIOS waits for the POST to complete. In block 292, the CPU 102 determines whether the POST was completed cleanly, i.e., with no significant error messages. If the result of this determination is positive, then control flows to block 293. If the result of this determination is negative, then control flows to block 294. In block 293, the initiator 122 and the RAID unit 120 are configured correctly, the POST exits and the BIOS initiates the operating system of the computer system 100.

In block 294, the PCI card 110 forces the computer system 100 to reset. In one embodiment, the processor 114 of the PCI card 110 sends a message or instruction to the BIOS executed by CPU 102, wherein the message forces a reset or re-boot of the computer system 100. In one example, the processor 114 executes this function by sending to the CPU 102 an interrupt 19, which is the software interrupt that handles the boot function. In block 296, the computer system 100 resets and control flows back to block 210.

The embodiments of the invention can take the form of an entirely hardware embodiment, an entirely software embodiment or an embodiment containing both hardware and software elements. In one embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for supporting multiple interface standards in a connection between a computer system and a Redundant Array of Independent Disks (RAID) unit, comprising:
receiving a message indicating an initialization routine;
reading a first indicator associated with a first interface standard;
loading configuration data for the first interface standard;
if the first interface standard is identical to the actual interface standard to which the RAID unit is coupled, configuring a RAID initiator using the configuration data.

2. The method of claim 1, further comprising:
if the first interface standard is not identical to the actual interface standard to which the RAID unit is coupled, storing a second indicator associated with a second interface standard.

3. The method of claim 2, further comprising:
if the first interface standard is not identical to the actual interface standard to which the RAID unit is coupled, re-initiating the initialization routine.

4. The method of claim 3, further comprising:
reading the second indicator associated with the second interface standard;
loading configuration data for the second interface standard;
configuring the RAID initiator using the configuration data, since the second interface standard is identical to the actual interface standard to which the RAID unit is coupled.

5. The method of claim 4, wherein the first interface standard and the second interface standard correspond to either the Small Computer System Interface (SCSI) interface standard or the Serial Attached SCSI (SAS) interface standard.

6. The method of claim 1, wherein the step of receiving comprises:
receiving a message from a Power On Self Test (POST) program of the computer system.

7. The method of claim 6, wherein the step of reading comprises:
reading a bit associated with an interface standard, wherein a first value of the bit indicates a first interface standard and a second value of the bit indicates a second interface standard.

8. The method of claim 7, wherein the step of loading comprises:
loading configuration data for an interface standard corresponding to a value of the bit.

9. The method of claim 6, wherein the step of reading comprises:
reading a first indicator associated with either a Small Computer System Interface (SCSI) interface standard or a Serial Attached SCSI (SAS) interface standard.

10. The method of claim 6, wherein the step of reading comprises:
reading a single bit associated with either a Small Computer System Interface (SCSI) interface standard or a Serial Attached SCSI (SAS) interface standard.

11. An apparatus for supporting multiple interface standards in a connection between a computer system and a Redundant Array of Independent Disks (RAID) unit, comprising:
a receiver for receiving a message indicating an initialization routine;
memory for storing a first indicator associated with a first interface standard; and
a processor configured for reading the first indicator, loading configuration data for the first interface standard and configuring a RAID initiator using the configuration data, if the first interface standard is identical to the actual interface standard to which the RAID unit is coupled.

12. The apparatus of claim 11, wherein the processor is further configured for storing a second indicator associated with a second interface standard, if the first interface standard is not identical to the actual interface standard to which the RAID unit is coupled.

13. The apparatus of claim 12, wherein the processor is further configured for re-initiating the initialization routine if the first interface standard is not identical to the actual interface standard to which the RAID unit is coupled.

14. The apparatus of claim 13, wherein the processor is further configured for reading the second indicator, loading configuration data for the second interface standard and configuring a RAID initiator using the configuration data, since the second interface standard is identical to the actual interface standard to which the RAID unit is coupled.

15. The apparatus of claim 14, wherein the indicator indicates either a Small Computer System Interface (SCSI) interface standard or a Serial Attached SCSI (SAS) interface standard.

16. The apparatus of claim 15, wherein the indicator is a single bit.

17. A computer program product comprising a computer usable medium embodying computer usable program code for supporting multiple interface standards in a connection between a computer system and a Redundant Array of Independent Disks (RAID) unit, the computer program product comprising:
computer usable program code for receiving a message indicating an initialization routine;
computer usable program code for reading a first indicator associated with a first interface standard;
computer usable program code for loading configuration data for the first interface standard; and
computer usable program code for configuring a RAID initiator using the configuration data if the first interface standard is identical to the actual interface standard to which the RAID unit is coupled.

18. The computer program product of claim 17, further comprising computer usable program code for storing a second indicator associated with the actual interface standard if the first interface standard is not identical to the actual interface standard to which the RAID unit is coupled.

19. The computer program product of claim 18, further comprising computer usable program code for re-initiating the initialization routine if the first interface standard is not identical to the actual interface standard to which the RAID unit is coupled.

20. The computer program product of claim 19, further comprising:
computer usable program code for reading the second indicator associated with a second interface standard;
computer usable program code for loading configuration data for the second interface standard; and
computer usable program code for configuring the RAID initiator using the configuration data, since the second interface standard is identical to the actual interface standard to which the RAID unit is coupled.
